(19) United States
(12) Patent Application Publication
(10) Pub. No.: US 2009/0135438 A1
(43) Pub. Date: May 28, 2009

(54) Printing Device With Image Customization

(75) Inventors: Vivek Chopra, Choa Chu Kang (SG); Sandeep Kumar Arya, Northvale (SG)

Correspondence Address: HAYNES AND BOONE, LLP;IP Section, 2323 Victory Avenue, Suite 700, Dallas, TX, 75219, US

(73) Assignee: DELL PRODUCTS L.P., Round Rock, TX (US)

(21) Appl. No.: 11/946,194

(22) Filed: Nov. 28, 2007

(51) Int. Cl. G06F 15/00

(52) U.S. Cl. 358/1.6

(57) ABSTRACT

A standalone printing device includes an image customization engine, an input device coupled to the image customization engine, and a display coupled to the image customization engine, wherein the image customization engine is operable to receive an image, to receive instructions through the input device to customize the image with a plurality of image customization resources, and to display the customized image on the display.

### BACKGROUND

The present disclosure relates generally to information handling systems, and more particularly to a printing device with image customization.

As the value and use of information continues to increase, individuals and businesses seek additional ways to process and store information. One option is an information handling system (IHS). An IHS generally processes, compiles, stores, and/or communicates information or data for business, personal, or other purposes. Because technology and information handling needs and requirements may vary between different applications, IHSs may also vary regarding what information is handled, how the information is handled, how much information is processed, stored, or communicated, and how quickly and efficiently the information may be processed, stored, or communicated. The variations in IHSs allow for IHSs to be general or configured for a specific user or specific use such as financial transaction processing, airline reservations, enterprise data storage, or global communications. In addition, IHSs may include a variety of hardware and software components that may be configured to process, store, and communicate information and may include one or more computer systems, data storage systems, and networking systems.

Sometimes it is desirable to print images (e.g., digital photographs) from a printer that is separate from the IHS (i.e., not directly connected to the IHS.) These printers are typically referred to as “standalone printers”, and their use to print images may raise a number of issues.

When printing an image on a standalone printer, a user may wish to customize the image in a number of ways. For example, the user may want to add a frame to the image. Some standalone printers are provided with a printer memory that includes a plurality of default frames, and the user may select a default frame to customize the image. However, the number of default frames provided on the printer memory is limited, and the user must access software applications that are provided on the IHS and edit the image on the IHS in order to overcome this limitation, which negates the purpose of the standalone printer. In addition, other desirable customization features are not available on standalone printers.

Accordingly, it would be desirable to provide an improved printing device with image customization for an information handling system.

### SUMMARY

According to one embodiment, a standalone printing device includes an image customization engine, an input device coupled to the image customization engine, and a display coupled to the image customization engine, wherein the image customization engine is operable to receive an image, to receive instructions through the input device to customize the image with a plurality of image customization resources, and to display the customized image on the display.

### BRIEF DESCRIPTION OF THE DRAWINGS

FIG. 1 is a schematic view illustrating an embodiment of an IHS.

FIG. 2a is a perspective view illustrating an embodiment of a standalone printer.

FIG. 2b is a schematic view illustrating an embodiment of the standalone printer of FIG. 2a.

FIG. 3a is a flow chart illustrating an embodiment of a method for customizing an image.

FIG. 3b is a screenshot illustrating an embodiment of a Resources Browser screen displayed on the standalone printer of FIGS. 2a and 2b.

FIG. 4a is a flow chart illustrating an embodiment of a portion of a method for customizing an image.

FIG. 4b is a flow chart illustrating an embodiment of a portion of a method for customizing an image.

FIG. 4c is a screenshot illustrating an embodiment of a Image Display screen displayed on the standalone printer of FIGS. 2a and 2b.

FIG. 4d is a screenshot illustrating an embodiment of a Modified Image screen displayed on the standalone printer of FIGS. 2a and 2b.

FIG. 4e is a screenshot illustrating an embodiment of a Modified Image screen displayed on the standalone printer of FIGS. 2a and 2b.

FIG. 4f is a screenshot illustrating an embodiment of a Modified Image screen displayed on the standalone printer of FIGS. 2a and 2b.

### DETAILED DESCRIPTION

For purposes of this disclosure, an IHS may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, entertainment, or other purposes. For example, an IHS may be a personal computer, a PDA, a consumer electronic device, a network server or storage device, a switch router or other network communication device, or any other suitable device and may vary in size, shape, performance, functionality, and price. The IHS may include memory, one or more processing resources such as a central processing unit (CPU) or hardware or software control logic. Additional components of the IHS may include one or more storage devices, one or more communications ports for communicating with external devices as well as various input and output (I/O) devices, such as a keyboard, a mouse, and a video display. The IHS may also include one or more buses operable to transmit communications between the various hardware components.

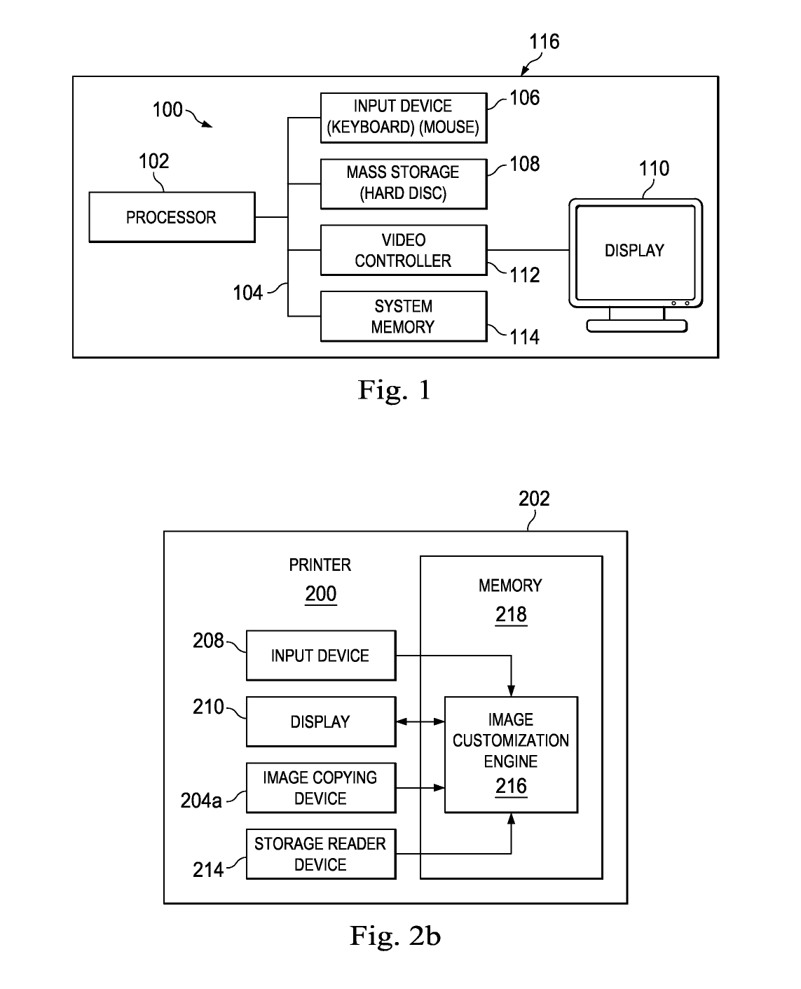

In one embodiment, IHS 100, FIG. 1, includes a processor 102, which is connected to a bus 104. Bus 104 serves as a connection between processor 102 and other components of computer system 100. An input device 106 is coupled to processor 102 to provide input to processor 102. Examples of input devices include keyboards, touchscreens, and pointing devices such as mouses, trackballs and trackpads. Programs and data are stored on a mass storage device 108, which is coupled to processor 102. Mass storage devices include such devices as hard disks, optical disks, magneto-optical drives, floppy drives and the like. IHS 100 further includes a display 110, which is coupled to processor 102 by a video controller 112. A system memory 114 is coupled to processor 102 to provide the processor with fast storage to facilitate execution of computer programs by processor 102. In an embodiment, a chassis 116 houses some or all of the components of IHS 100. It should be understood that other buses and intermediate circuits can be deployed between the components described above and processor 102 to facilitate interconnection between the components and the processor 102.

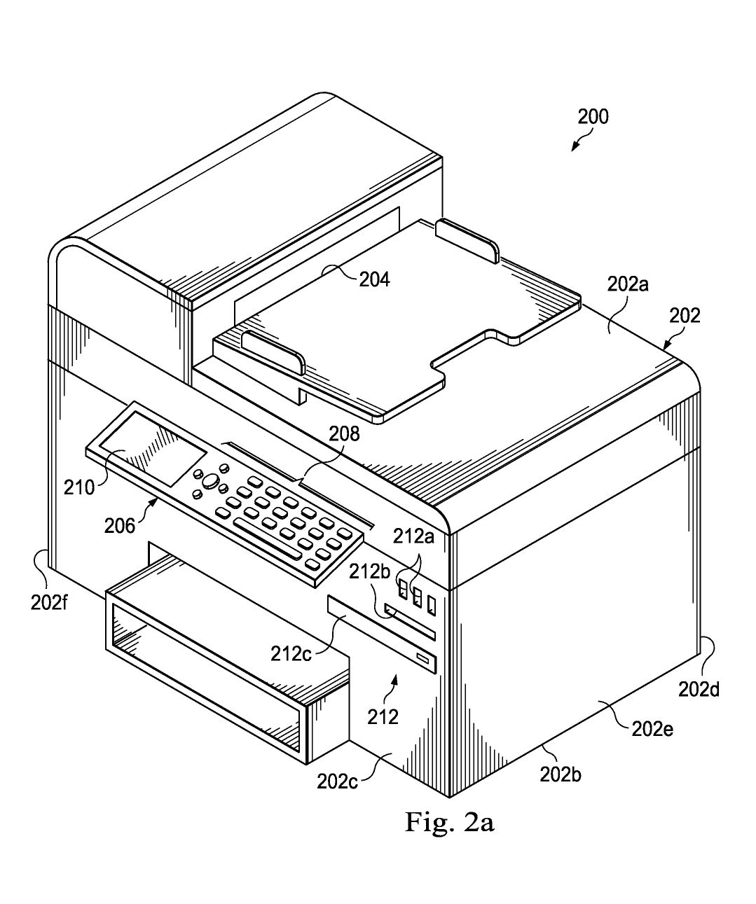

Referring now to FIGS. 2a and 2b, a standalone printer 200 is illustrated. A standalone printer is a printer that is operable to receive images and print those images without being connected to an IHS (e.g., a desktop computer, a portable computer, and/or a computer network.) A standalone printer may receive images in a variety of manners such as, for example, transferred from a digital camera, copied or scanned by the standalone printer, and/or read off of a portable memory device (e.g. a compact disc (CD), a digital video disc (DVD), a flash memory card type device, and/or a variety of other portable memory devices known in the art.) The standalone printer need only be coupled to a power source for images to be received by the standalone printer and printed. While the standalone printer may be operable to couple to an IHS such as, for example, the IHS 100 described above with reference to FIG. 1, it does not require such a coupling to receive, customize, and print images. The standalone printer 200 may be connected to the Internet using methods known in the art (e.g., wirelessly or through a networking cable.) The standalone printer 200 includes a chassis 202 having a top surface 202a, a bottom surface 202b located opposite the top surface 202a, a front surface 202c extending between the top surface 202a and the bottom surface 202b, a rear surface 202d located opposite the front surface 202c and extending between the top surface 202a and the bottom surface 202b, and a pair of opposing side surface 202e and 202f extending between the top surface 202a, the bottom surface 202b, the front surface 202c, and the rear surface 202d. An image copying inlet 204 is located on the top surface 202a of the standalone printer 200 and provides access to devices in the standalone printer 200 such as, for example, an image copying device 204a, an image intake device (not shown), and/or a variety of other printer/copier devices known in the art. A control panel 206 extends from the front surface 202c of the standalone printer 200 and includes an input device 208 and a display 210. In an embodiment, the input device 208 includes a keyboard and a directional control that may control, for example, a cursor on the display 210. In an embodiment, the display 210 may part of the input device 208 such as, for example, by including touch screen functionality that allows a user to provide input by touching the surface of the display 210. A plurality of storage device inputs 212 are located on the front surface 202c of the standalone printer 200 and coupled to a storage device reader 214 in the standalone printer 200. The storage device inputs 212 may include, for example, a plurality of Universal Serial Bus (USB) ports 212a, a card reader 212b, an optical drive 212c, and/or a variety of other storage device inputs known in the art. The image copying device 204a, the input device 208, the display 210, and the storage device reader 214 are all coupled to an image customization engine 216 that may be, for example, software stored on a computer-readable medium such as, for example, a memory 218 located in the standalone printer 200. In an embodiment, the memory 218 may store a plurality of image customization resources such as, for example, frame resources, caption resources, image editing software, and a variety of other image customization resources known in the art.

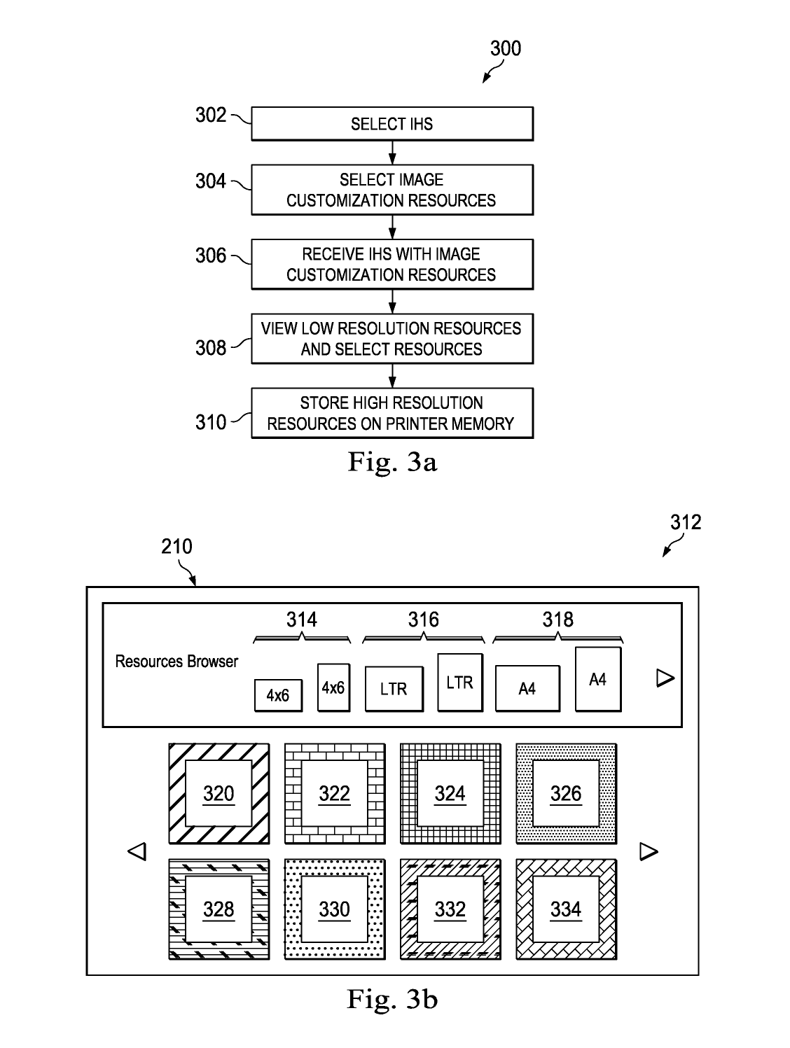

Referring now to FIGS. 2a, 2b, 3a and 3b, a method 300 for customizing an image is illustrated. The method 300 begins at block 302 where an IHS is selected. A customer may select an IHS such as, for example, the IHS 100 described above with reference to FIG. 1, to purchase from an IHS supplier using a variety of methods known in the art. The method 300 then proceeds to block 304 where image customization resources are selected. As part of the IHS selection process, the IHS supplier may offer the customer image customization resources such as, for example, frame resources, caption resources, editing software, and/or a variety of other image customization resources known in the art. The customer may select desired image customization resources and those image customization resources may be stored in a high resolution format on the IHS selected by the customer in block 302 of the method 300. The method 300 then proceeds to block 306 where the IHS with the image customization resources is received. The IHS with the stored high resolution format image customization resources is shipped by the IHS supplier to the customer. Once the customer receives the IHS, the customer may copy the image customization resources in a low resolution format to the standalone printer 200 using methods known in the art. Storing the image customization resources in a low resolution format on the memory 218 of the standalone printer 200 avoids the unnecessary use of the memory 218 for high resolution image customization resources that the customer will not use. In an embodiment, the low resolution image customization resources may be stored on a storage device connected to the standalone printer 200. In an embodiment the high resolution format may be, for example, a bitmap image format, and the low resolution format may be, for example, a jpeg image format. In an embodiment, an image that is in the high resolution format is of a resolution that is higher than the resolution of the same image in the low resolution format. The method 300 then proceeds to block 308 where low resolution image customization resources are viewed and selected. The customer may view a resources browser 312 on the display 210 of the control panel 206 on the standalone printer 200. The Resources Browser 312 may display a plurality of media size and orientation options such as, for example, a pair of 4×6 options 314 in different orientations, a pair of Letter options 316 in different orientations, a pair of A4 options 318 in different orientations, and/or a variety of other media size and orientation options known in the art. The resources browser 312 also displays a plurality of frame resources 320, 322, 324, 326, 328, 330, 332 and 334 in a low resolution format. The plurality of frame resources 320, 322, 324, 326, 328, 330, 332 and 334 in the illustrated embodiment are merely exemplary, and one of skill in the art will recognize that a variety of frame resources and other image customization resources may be displayed by the Resources Browser 312. In an embodiment, the customer may select the frame resource 320. The method 300 then proceeds to block 310 where resources are stored on the printer memory in a high resolution format. The image customization engine 216 may then access the frame resource 320 in a high resolution format on, for example, the IHS 100, and transfer that high resolution frame resource to the memory 218 of the standalone printer 200. In an embodiment, blocks 302, 304 and 306 of the method 300 may be omitted, and the image customization resources in low resolution format may be copied to the memory 218 of the standalone printer 200 over an Internet connection, such that at blocks 308 and 310 of the method 300, the image customization resources are selected in a low resolution format and then retrieved by the image customization engine 216 in a high resolution format from the Internet and stored on the memory 218 of the standalone printer 200. In an embodiment, image customization resources stored on the memory 218 of the standalone printer 200 in a high resolution format may be periodically erased from the memory 218, for example, when the image customization resource has not been used to customize an image for a predetermined amount of time. Thus, a method is provided to provide image customization resources on a standalone printer that conserves memory space on the standalone printer.

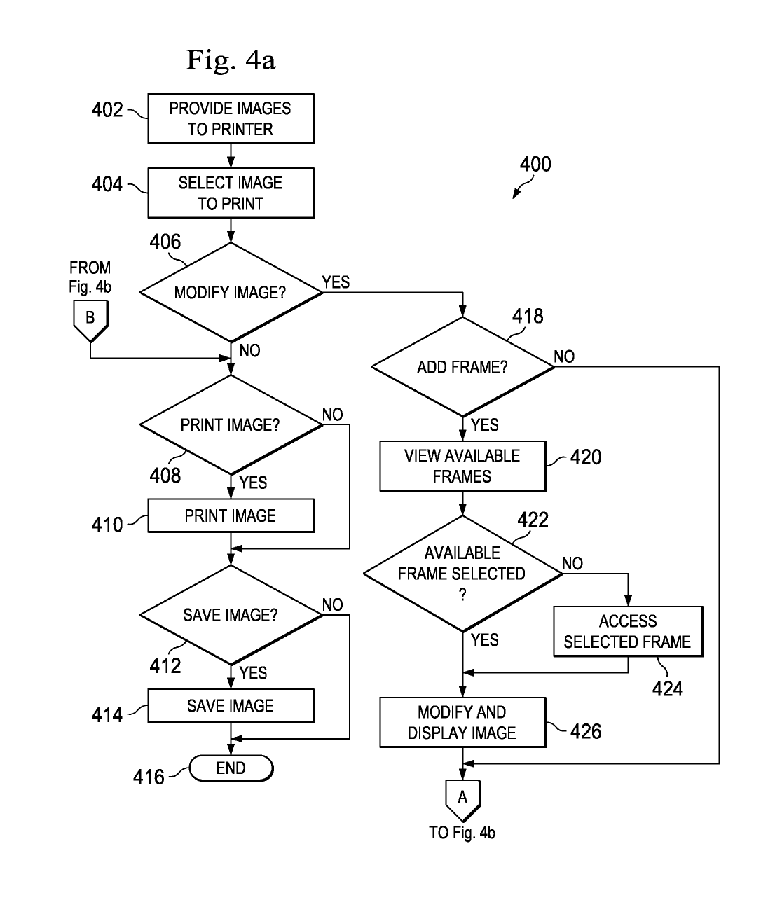

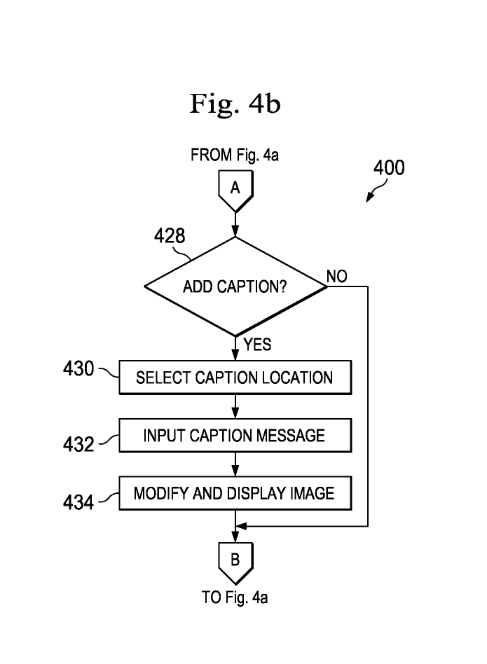

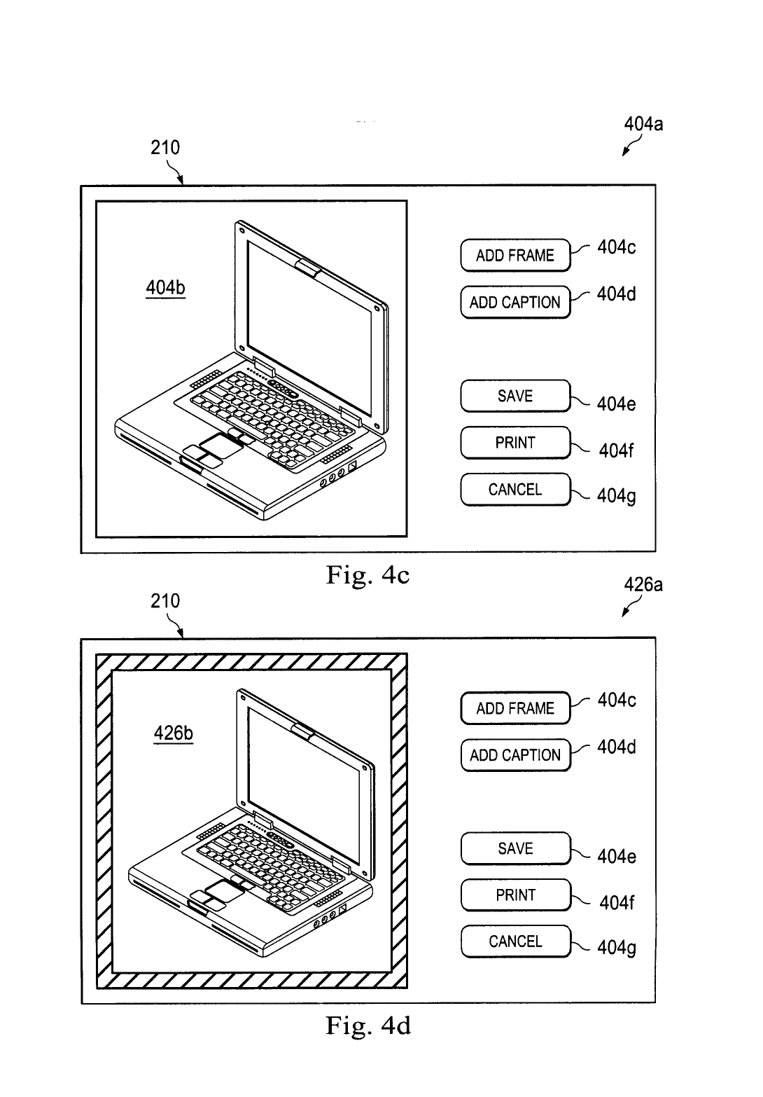

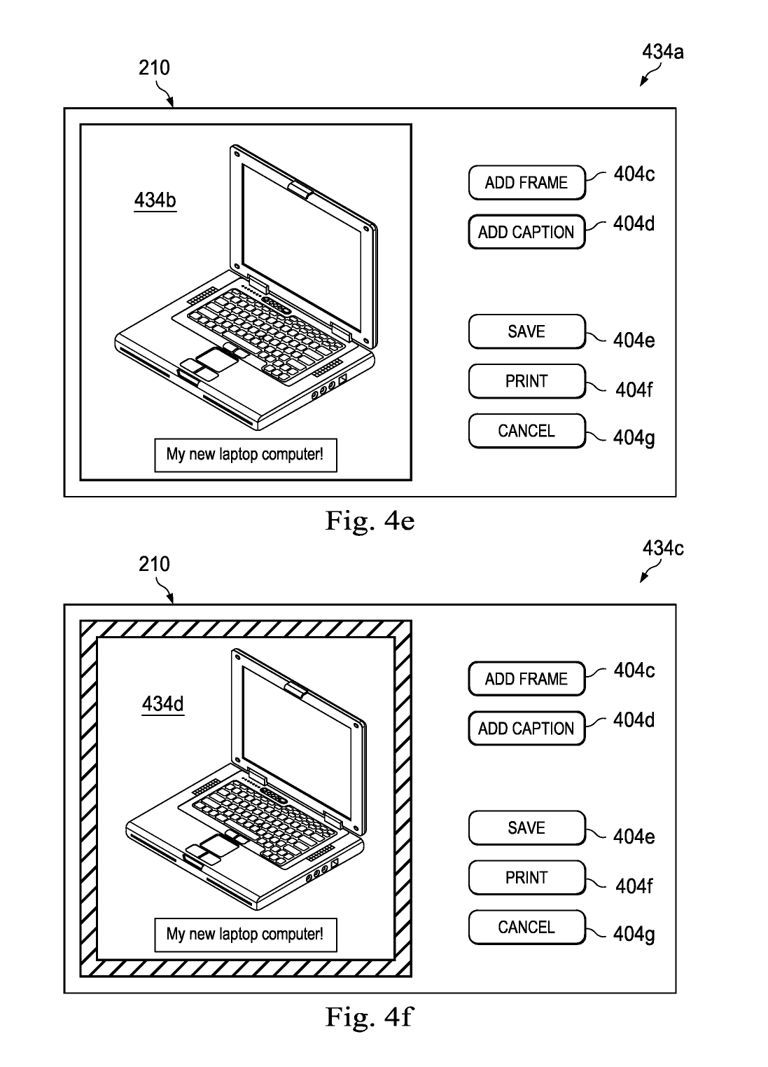

Referring now to FIGS. 2a, 2b, 4a and 4c, a method 400 for customizing an image is illustrated. The method 400 begins at block 402 where images are provided to the standalone printer 200. In the illustrated embodiment, the standalone printer 200 includes a plurality of image customization resources such as, for example, frame resources, caption resources, editing resources, and variety of other image customization resources known in the art. The image customization resources may be stored on the memory 218 of the standalone printer 200, for example, as described above with reference to the method 300. A user may then provide images to the standalone printer 200 by, for example, by connecting a digital camera including images to the standalone printer 200 through the USB ports 212a, by connecting a card including images to the card reader 212b, by inserting a CD or DVD including images in the optical drive 212c, by running an image through the image copying device 204a, and/or in a variety of other manners known in the art. The image copying device 204a and/or the storage device reader 214 may then provide the image(s) to the image customization engine 216. The method 400 then proceeds to block 404 where an image is selected to print. The image customization engine 216 displays the image(s) on the display 210 such that the user may select an image to print. In an embodiment, the user may select the image to print using the input device 208. In an embodiment, the display 210 may be a touch screen and the user may select an image to print by touching the image as displayed by the display 210. In an embodiment, upon selection of the image to print, the image customization engine 216 may provide an Image Display screen 404a on the display 210 that includes the selected image 404b, an Add Frame button 404c, an Add Caption button 404d, a Save button 404e, a Print button 404f, and a Cancel button 404g. In an embodiment, the user may select the buttons 404c, 404d, 404e, 404f and 404g using the input device 208. In an embodiment, the display 210 may be a touch screen and the user may select the buttons 404c, 404d, 404e, 404f and 404g by touching the buttons 404c, 404d, 404e, 404f and 404g as displayed by the display 210. The buttons 404c, 404d, 404e, 404f and 404g may be available on the display 210 throughout the method 400 and their functions will be explained in further detail below.

The method 400 then proceeds to decision block 406 where it is determined whether the user would like to modify the image 404b. In an embodiment, the user may indicate that they wish to modify the image 404b by selecting the Add Frame button 404c or the Add Caption button 404d. If the user would not like the modify the image 404b, the method 400 proceeds to decision block 408 where it is determined whether the user would like to print the image 404b. In an embodiment, the user may indicate that they wish to print the image 404b by selecting the Print button 404f. If the user would like to print the image 404b, the image 404b is printed by the standalone printer at block 410. Once the image 404b is printed, or if the user decided to not print the image 404b at decision block 408, the method 400 proceeds to decision block 412 where it is determined whether the user would like to save the image 404b. In an embodiment, the user may indicate that they wish to save the image 404b by selecting the Save button 404e. If the user would like to save the image 404b, the image 404b is saved at block 414. In an embodiment, the image 404b may be saved to a storage device coupled to the storage device inputs 212, to the memory 218 of the standalone printer 200, or to a variety of other locations known in the art. Once the image 404b is saved, or if the user decided to not save the image 404b at decision block 412, the method 400 proceeds to block 416 where the method 400 ends.

Referring now to FIGS. 4a, 4b, 4c and 4d, at decision block 406, the user may have indicated that they desire to modify the image 404b. In an embodiment, the user may indicate that they wish to modify the image 404b by selecting the Add Frame button 404c or the Add Caption button 404d. The method 400 then proceeds to decision block 418, where it is determined whether the user would like to add a frame to the image 404b. If the image customization engine 216 determines that the user selected the Add Frame button 404c, the method 400 proceeds to block 420 where the image customization engine 216 displays the available frames on the display 210 for the user to view. In an embodiment, a screen similar to the Resources Browser 312 is provided on the display 210 to display the frames available to the user. In an embodiment, the frames displayed on the display 210 by the image customization engine 216 are frames stored on the memory 218 in a low resolution format. In an embodiment, the frames displayed on the display 210 by the image customization engine 216 are frames stored on the memory 218 in a high resolution format. The method 400 then proceeds to decision block 422 where it is determine whether an available frame has been selected. In an embodiment, an available frame is a frame that is stored on the memory 218 of the standalone printer 200 in a high resolution format. In an embodiment, an unavailable frame is a frame that is stored on the memory 218 of the standalone printer 200 in a low resolution format but is accessible by the image customization engine 216 in a high resolution format in another location. If an unavailable frame has been selected, the method 400 proceeds to block 424 where the image customization engine 216 accesses the selected frame by, for example, accessing a storage device coupled to the standalone printer 200, accessing the Internet, and/or using variety of other methods known in the art. If an available frame was selected at decision block 422, or the image customization engine 216 has accessed the selected image at block 424, the method 400 proceeds to block 426 where the image 404b is modified and displayed. In an embodiment, the image customization engine 216 displays a Modified Image screen 426a on the display 210 including a modified image 426b that displays the image 404b selected in block 404 of the method 400 framed by the frame selected in block 420 of the method 400.

Referring now to FIGS. 4a, 4b, 4c, 4e and 4f, if the user decided to not add a frame at decision block 418, the method 400 proceeds to decision block 428, where it is determined whether the user would like to add a caption to the image 4040b. If the image customization engine determines that the user selected the Add Caption button 404d, the method 400 proceeds to block 430 where a caption location is selected. In an embodiment, the user may select the location of the caption using the input device 208. In an embodiment, the display 210 may be a touch screen and the user may select the location of the caption by touching the area on the image 4040b that is displayed by the display 210. In an embodiment, a default caption location may be provided. The method 400 then proceeds to block 432 where a caption message is input. In an embodiment, the user may provide the caption message using the input device 208. In an embodiment, the display 210 may be a touch screen and the user may provide the caption message, for example, by using a touch sensitive keyboard that is displayed by the display 210. In an embodiment, the user may be allowed to select message attributes such as, for example, a font. The method 400 the proceeds to block 434 where the image 404b is modified and displayed. In an embodiment, the image customization engine 216 displays a modified image screen 434a on the display 210 including a modified image 434b that displays the image 404b selected in block 404 of the method 400 with a caption in the location selected in block 430 and including the message input in block 432 of the method 400.

Referring now to FIGS. 4a, 4b, 4c, 4e and 4f, after block 426 of the method 400 in which the user has added a frame to the image 404b, the method 400 proceeds to decision block 428, where it is determined whether the user would like to add a caption to the image 426b. If the image customization engine determines that the user selected the Add Caption button 404d, the method 400 proceeds to block 430 where a caption location is selected. In an embodiment, the user may select the location of the caption using the input device 208. In an embodiment, the display 210 may be a touch screen and the user may select the location of the caption by touching the area on the image 426b that is displayed by the display 210. In an embodiment, a default caption location may be provided. The method 400 then proceeds to block 432 where a caption message is input. In an embodiment, the user may provide the caption message using the input device 208. In an embodiment, the display 210 may be a touch screen and the user may provide the caption message, for example, by using a touch sensitive keyboard that is displayed by the display 210. In an embodiment, the user may be allowed to select massage attributes such as, for example, a font. The method 400 then proceeds to block 434 where the image 426b is modified and displayed. In an embodiment, the image customization engine 216 displays a modified image screen 434c on the display 210 including a modified image 434d that displays the image 404b selected in block 404 of the method 400, the frame selected in block 420 of the method 400, and a caption in the location selected in block 430 and including the message input in block 432 of the method 400.

Referring now to FIGS. 4a and 4b, if it is determined that the user would not like to add a caption to the image 404b or 426b at decision block 428 of the method 400, or after block 434 of the method 400, the method 400 proceeds to decision blocks 408 and 412, and blocks 410, 414 and 416 where the image may be printed and/or saved as described above. Thus, a system and method are provided that allow images to be viewed, customized, and saved using a standalone printer without the need for the standalone printer to access software applications on another system. The system and method also allow image customization resources to be viewed in a low resolution format on the standalone printer and then selected image customization resources to be saved in a high resolution format to conserve memory on the standalone printer.

Although illustrative embodiments have been shown and described, a wide range of modification, change and substitution is contemplated in the foregoing disclosure and in some instances, some features of the embodiments may be employed without a corresponding use of other features. Accordingly, it is appropriate that the appended claims be construed broadly and in a manner consistent with the scope of the embodiments disclosed herein.

1. A standalone printing device, comprising:
an image customization engine;
an input device coupled to the image customization engine; and
a display coupled to the image customization engine, wherein the image customization engine is operable to receive an image, to receive instructions through the input device to customize the image with a plurality of image customization resources, and to display the customized image on the display.

2. The device of claim 1, wherein the image customization engine is operable to save the customized image.

3. The device of claim 1, wherein the image customization engine is operable to provide at least one of the plurality of image customization resources to be viewed for selection on the display in a first resolution, and wherein selected image customization resources may be saved to a printer memory in second resolution that is higher than the first resolution.

4. The device of claim 1, wherein the image customization engine is operable to download image customization resources through the Internet.

5. The device of claim 1, wherein further comprising:
a memory device coupled to the image customization engine.

6. The device of claim 5, wherein at least one of the plurality of image customization resources are installed on an information handling system and then transferred to the memory device.

7. The device of claim 1, wherein at least one of the plurality of image customization resources comprise a frame resource.

8. The device of claim 1, wherein at least one of the plurality of image customization resources comprise a caption resource.

9. A method for customizing an image, comprising:
ordering an information handling system from a supplier, wherein the ordering comprises selecting a plurality of image customization resources to be included with the information handling system;
receiving the information handling system from the supplier;
transferring at least one of the image customization resources to a standalone printer; and
customizing an image on the standalone printer using at least one of the image customization resources.

10. The method of claim 9, wherein at least one of the plurality of image customization resources comprise a frame resource.

11. The method of claim 9, wherein at least one of the plurality of image customization resources comprise a caption resource

12. The method of claim 9, further comprising:
saving the customized image on a storage device coupled to the standalone printer.

13. The method of claim 9, wherein the transferring at least one of the image customization resources to a standalone printer comprises transferring the at least one of the image customization resources to a memory device coupled to the standalone printer.

14. The method of claim 9, further comprising:
printing the customized image using the standalone printer.

15. The method of claim 9, wherein the transferring at least one of the image customization resources to a standalone printer comprises:
transferring the at least one of the image customization resources to the standalone printer in a first resolution;
selecting the at least one of the image customization resources; and
transferring the at least one of the image customization resources to the standalone printer in a second resolution that is higher than the first resolution.

16. A method for customizing an image, comprising:
retrieving and viewing an image on a display located on a standalone printer;
selecting a desired frame resource on the standalone printer;
customizing the image using the frame resource, wherein the customized image is displayed on the display;
selecting a caption resource on the standalone printer; and
customizing the image using the caption resource, wherein the customized image is displayed on the display.

17. The method of claim 16, further comprising:
printing the image using the standalone printer.

18. The method of claim 16, further comprising:
saving the image on a storage device coupled to the standalone printer.

19. The method of claim 16, wherein the selecting a desired frame resource on the standalone printer comprises:
viewing a plurality of frame resources on the display in a first resolution;
selecting a desired frame resource;
retrieving the desired frame resource in a second resolution that is higher than the first resolution; and
using the desired frame resource to customize the image.

20. The method of claim 16, wherein the customizing the image using the caption resource comprises selecting a location on the image for a caption and providing a plurality of text for the caption.
